(19) United States
(12) Patent Application Publication
(10) Pub. No.: US 2022/0350002 A1
(43) Pub. Date: Nov. 3, 2022

(54) METHOD AND DEVICE FOR MEASURING TIME OF FLIGHT, STORAGE MEDIUM, AND LIDAR

(71) Applicant: SUTENG INNOVATION TECHNOLOGY CO., LTD., Shenzhen (CN)

(72) Inventor: Xiaojun ZHOU, Shenzhen (CN)

(73) Assignee: SUTENG INNOVATION TECHNOLOGY CO., LTD., Shenzhen (CN)

(21) Appl. No.: 17/868,655

(22) Filed: Jul. 19, 2022

Related U.S. Application Data
(63) Continuation of application No. PCT/CN2020/101118, filed on Jul. 9, 2020.

(30) Foreign Application Priority Data
Jan. 20, 2020 (CN) PCT/CN2020/073251

(51) Int. Cl. G01S 7/4865; G01S 17/10

(52) U.S. Cl. CPC G01S 7/4865; G01S 17/10

(57) ABSTRACT

The present application discloses a method and device for measuring time of flight and a LiDAR, and belongs to the field of ranging. In the present application, because a shared device of a first transmission link and a second transmission link is a temperature-sensitive device, the delay time of the temperature-sensitive device may be eliminated according to the differential processing of first transmission time and second transmission time. Thus the measurement results of the time of flight are only related to the delay time of the non-temperature sensitive device, thereby reducing the problem of the inaccurate measurement of the time of flight of a target object caused by the temperature change of a device for measuring. Therefore, the accuracy of the measurement of the time of flight of the device for measuring is improved.

### CROSS-REFERENCE TO RELATED APPLICATION

The present application is a continuation of International Application No. PCT/CN2020/101118, filed on Jul. 9, 2020, and claims priority to International Application No. PCT/CN2020/073251, filed on Jan. 20, 2020, the contents of which are both incorporated herein by reference in their entireties.

### TECHNICAL FIELD

This application relates to the field of laser measurement, and in particular, to a method and device for measuring time of flight, storage medium, and LiDAR.

### BACKGROUND

LiDAR is a device that emits a laser beam to detect relevant parameters of a target object. The working principle of the LiDAR is to emit a detection laser beam to a target object, then compare signals reflected from the target object with emitting signals, and properly process the signals to obtain relevant parameters of the target object, such as distance, azimuth, height, speed, shape and other parameters of the target object.

The current LiDAR generally has a built-in photoelectric receiving device. The built-in photoelectric receiving device converts optical signals reflected by the target object into analog electrical signals, and then amplifies and transfers the analog electrical signals to an analog-to-digital converter (ADC). The analog-to-digital converter converts the analog electrical signals into digital signals, and then the digital signals are processed by signal processing such as detection to obtain time of flight of the target object relative to the LiDAR. The distance from the LiDAR to the target object is calculated according to the time of flight.

However, the inventor found that electronic devices such as a laser, a photoelectric receiving element, a chip, a capacitor, and a resistor in the LiDAR were sensitive to environmental parameters (such as temperature, humidity, or air pressure, etc.). For a target object at the same location, there may be a large difference in the time of flight measured under the different environmental parameters, which affects the accuracy of the LiDAR to measure the time of flight.

### SUMMARY

Embodiment of this application provides a method, device, storage medium and LiDAR for measuring time of flight, which may solve the problem of inaccurate measurement results of time of flight in the related art. Technical solutions are as follows.

In a first aspect, an embodiment of this application provides a method for measuring time of flight, where the method comprises:
transmitting reference signals in a first signal link, and determining first transmission time of the reference signals in the first signal link;
transmitting measurement signals in a second signal link, and determining second transmission time of the measurement signals in the second signal link, where a shared device of the first signal link and the second signal link is a temperature-sensitive device, and a non-shared device of the first signal link and the second signal link is a non-temperature-sensitive device;
acquiring delay time of the non-shared device; and
determining time of flight corresponding to a target object according to the first transmission time, the second transmission time, and the delay time of the non-shared device.

In a second aspect, an embodiment of this application provides a device for measuring time of flight, comprising:
a controller, a memory, a first signal link, and a second signal link, where the memory stores a computer program, and the computer program is configured to be loaded by the controller and execute a method which further includes:
   transmitting reference signals in the first signal link, and determining first transmission time of the reference signals in the first signal link;
   transmitting measurement signals in the second signal link, and determining second transmission time of the measurement signals in the second signal link, where a shared device of the first signal link and the second signal link is a temperature-sensitive device, and a non-shared device of the first signal link and the second signal link is a non-temperature-sensitive device;
   acquiring delay time of the non-shared device; and
   determining time of flight corresponding to a target object according to the first transmission time, the second transmission time, and the delay time of the non-shared device.

In a third aspect, an embodiment of this application provides a computer storage medium. The computer storage medium stores a plurality of instructions. The instructions are adapted to be loaded by a processor to execute the foregoing method.

In a fourth aspect, an embodiment of this application provides a LiDAR, comprising a processor and a memory. The memory stores a computer program. The computer program is adapted to be loaded by the processor to execute the foregoing method.

The beneficial effects provided by the technical solutions of embodiments of this application include at least:

When measuring the time of flight corresponding to the target object, the reference signals are transmitted in the first signal link. The first transmission time of the reference signals in the first signal link is measured. The measurement signals are transmitted in the second signal link. The transmission time of the measurement signals in the second signal link is measured. The first signal link and the second signal link in this application have the shared device. The shared device is a temperature-sensitive device, that is, the device whose delay time varies greatly as temperature changes. The non-shared device of the first signal link and the second signal link is a non-temperature sensitive device, that is, a device whose delay time remains basically unchanged as the temperature changes. According to the first transmission time, the second transmission time, and the delay time of the non-shared device, the time of flight corresponding to the target object is determined. In the embodiment of this application, since the shared device of the first transmission link and the second transmission link is the temperature-sensitive device, the delay time of the temperature-sensitive device may be eliminated by the differential processing of the first transmission time and the second transmission time. Thus the measurement results of the time of flight are only related to the delay time of the non-temperature sensitive device, thereby reducing the problem of the inaccurate measurement of the time of flight of the target object caused by the temperature change of a device for measuring, and improving the measurement accuracy of the device for measuring.

### BRIEF DESCRIPTION OF THE DRAWINGS

To explain embodiments of this application or the technical solutions in the related art more clearly, the following briefly introduces the drawings that need to be used in the embodiments or the related art. Obviously, the drawings in the following description are only some embodiments of this application. The person skilled in the art may obtain other drawings based on these drawings without inventive work.

FIG. 1 is a schematic diagram of the measurement principle of a device for measuring in the related art;

FIG. 2 is a schematic flowchart of a method for measuring time of flight according to an embodiment of this application;

FIG. 3 is a schematic structural diagram of a single-channel device for measuring according to an embodiment of this application;

FIG. 4 is a schematic structural diagram of a multi-channel device for measuring according to an embodiment of this application;

FIG. 5 is a schematic structural diagram of a device for measuring according to this application.

### DETAILED DESCRIPTION

To make the objectives, technical solutions and advantages of this application clearer, the following further describes the embodiments of this application in detail with reference to accompanying drawings and embodiments.

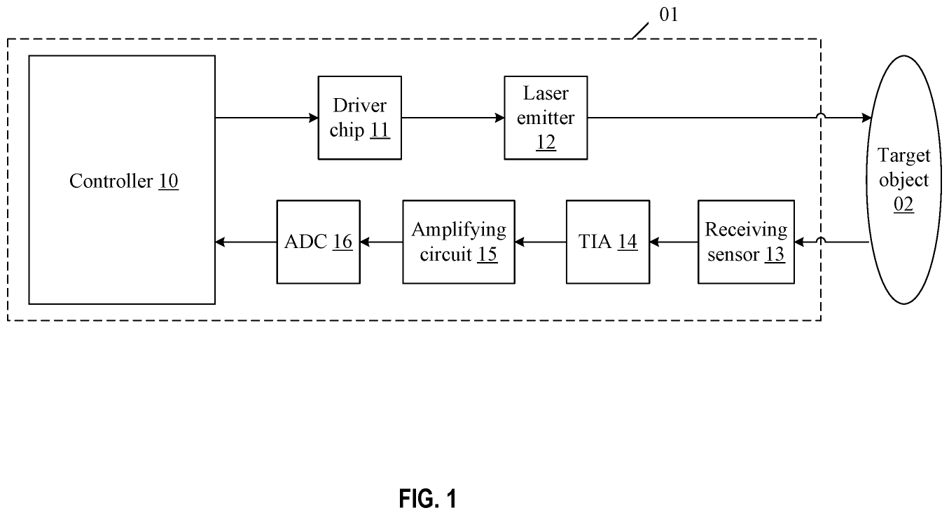

FIG. 1 shows a schematic diagram of the measurement principle of the measuring device in the related art. In FIG. 1, a measuring device 01 includes a controller 10, a driver chip 11, a laser emitter 12, a receiving sensor 13, a TIA (transimpedance amplifier) 14, an amplifying circuit 15, and an ADC (analog-to-digital converter) 16. The laser emitter 12 may consist of a gallium nitride MOS (metal-oxide-semiconductor) tube and a laser diode. The measuring device 01 is configured to measure time of flight between the measuring device 01 and a target object 02. The distance between the measuring device 01 and the target object 02 is determined according to the time of flight. The process of measuring the time of flight by the measuring device 01 includes:

The controller 10 sends control signals to the driver chip 11 via an output port. The driver chip 11 drives the laser emitter 12 to emit laser ranging signals according to the control signals. The laser ranging signals are reflected when they encounter an object ahead. The laser sensor 13 receives laser echo signals returning after the laser ranging signals are reflected by a target object, and converts the laser echo signals into current signals. The TIA 14 converts the current signals into voltage signals. An amplifying circuit 15 amplifies the voltage signals. The ADC 16 samples the amplified voltage signals to obtain digital signals (echo signals), and inputs the digital signals to an input port of the controller 10. The controller 10 determines time difference t according to the moment when the control signals are transmitted and the moment when corresponding echo signals are received. In addition to the time of flight, the time difference t also includes various delay links in FIG. 1. For example, the time difference t includes a plurality of time components shown in Table 1:

TABLE 1

| Delay link | Delay time |
|---|---|
| Emitting control delay | t1 |
| The delay of a driver chip | t2 |
| GaN conducting delay | t3 |
| LD emitting-light delay | t4 |
| Time of flight | t5 |
| The photoelectric conversion delay of | t6 |
| a receiving sensor | |
| The conversion delay of TIA | t7 |
| The delay of an amplifying circuit | t8 |
| The conversion delay of ADC | t9 |
| The data transmission delay of ADC | t10 |

According to Table 1, actual time of flight between the device for measuring and the target object is t5. A measured value of the time of flight is t=t1+t2+t3+t4+t5+t6+t7+t8+t9+t10. A measurement error is t1+t2+t3+t4+t6+t7+t8+t9+t10. In the related art, in order to reduce the measurement error, it is necessary to perform static calibration for each delay link, calculate the static error of each delay link, and then subtract the static error to obtain the actual measured value of the time of flight. The inventor found that some devices in the device for measuring were temperature-sensitive devices. The delay time varies greatly as temperature changes. For example, taking a certain type of driver chip as an example, when ambient temperature is 25° C., the delay time of the driver chip is 30 ns. When the ambient temperature ranges from −40° C. to 85° C., the maximum delay time of the driver chip is 35 ns. According to a ranging formula, an error of the time of flight of lns leads to a ranging error of 15 cm. If a static calibration method is used for determining the delay time of each device, there will be a larger error in the measurement results of the time of flight.

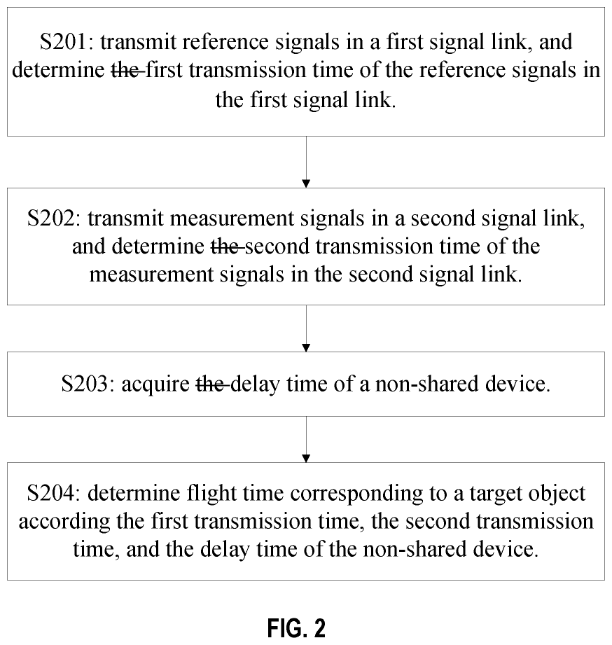

FIG. 2 is a schematic flowchart of a method for measuring time of flight according to an embodiment of this application. As shown in FIG. 2, the method may include the following steps.

S201: transmit reference signals in a first signal link, and determine first transmission time of the reference signals in the first signal link.

The first signal link is a signal link for transmitting reference signals. A plurality of devices in the first signal link are provided. The reference signals are signals with specified signal features generated by the controller. The signal features include one or more of frequency, amplitude and phase. The controller is provided with an input port and an output port. The output port is configured to transmit the signals. The input port is configured to receive the signals. The controller generates the reference signals, and transmits the reference signals in the first signal link via the output port. The reference signals reach the input port of the controller after passing through each device in the first signal link. Each device in the first signal link processes the reference signals accordingly, for example, driving, amplifying, analog-to-digital conversion, etc. The controller receives the reference signals via the input port. The controller determines the first transmission time of the reference signals in the first signal link according to the transmission time and the reception time of the reference signals.

S202: transmit measurement signals in a second signal link, and determine second transmission time of the measurement signals in the second signal link.

The second signal link is a signal link for transmitting the measurement signals. A plurality of devices in the second signal link are provided. The measurement signals are also signals with specified signal features. The controller generates the measurement signals, and then transmits the measurement signals in the second signal link via the input port. The measurement signals are photoelectrically converted to generate laser measurement signals. The laser measurement signals meet the target object and are reflected to form laser echo signals, which are then received by the device for measuring. The laser echo signals are photoelectrically converted to generate electrical signals again by the device for measuring and then the electrical signals reach the input port of the controller. The device for measuring determines the second transmission time according to the transmission time and the reception time of the measurement signals.

The plurality of devices in the first signal link are provided. The plurality of devices in the second signal link are provided. The first signal link and the second signal link have a shared device, and the shared device is a temperature-sensitive device. The temperature-sensitive device is a device whose delay time varies greatly as temperature changes. Any device other than the shared device in the first signal link and the second signal link is referred to as a “non-shared device” in this application. All non-shared devices are non-temperature sensitive devices, that is, the delay time of the non-temperature sensitive devices changes insignificantly as temperature changes. The measurement signals are configured to measure the time of flight. The second signal link of this application includes a signal link corresponding to the time of flight, that is, a signal link which the laser measurement signals and the laser echo signals pass through.

For example, the devices in the first signal link are a device A, a device B, a device C, and a device D. The devices in the second signal link are the device A, the device B, the device D, a device E, and a device F. The shared devices in the first signal link are the device A, the device B, and the device D. The foregoing three devices are all temperature-sensitive devices. The non-shared devices in the first signal link and the second signal link are the device C, the device E, and the device F. The foregoing three devices are all non-temperature sensitive devices.

S203: acquire delay time of the non-shared device.

The delay time of the non-shared device may be pre-stored in a memory. The non-shared device of the first signal link and the second signal link is a non-temperature sensitive device. Therefore, the delay time of the non-shared device may be determined by static calibration. Then, the delay time of each non-shared device acquired by the static calibration is stored in the memory. The controller reads the delay time of the non-shared device from the memory.

For example, according to the example of S202, the non-shared devices are the device C, the device E, and the device F. The delay time t_{C} of the device C, the delay time t_{E} of the device E, and the delay time t_{F} of the device F are pre-stored in the memory. The controller reads the delay time of the foregoing three non-shared devices from the memory.

S204: determine time of flight corresponding to the target object according to the first transmission time, the second transmission time, and the delay time of the non-shared device.

The time of flight is time difference between the laser measurement signals emitted by the device for measuring and the laser echo signals received by the device for measuring. The second signal link in this application includes a signal link for transmitting the laser measurement signals and the laser echo signals. Since the shared device of the first signal link and the second signal link is a temperature-sensitive device, the transmission time of the second signal link and the transmission time of the first signal link are differentially processed, which may eliminate the influence of the delay time of the temperature-sensitive device on the measurement results of the time of flight and may improve the measurement accuracy of the time of flight.

For example, according to the example of S202, assuming that the first transmission time is t_{T1} and the second transmission time is t_{T2}, then t_{T2}−t_{T1}=t_{TOF}+t_{E}+t_{F}−t_{C}, t_{TOF}=t_{T2}−t_{T1}−t_{E}−t_{F}+t_{C}.

In one or more possible implementations, the devices in the first signal link include a driver chip, a reference signal conditioning circuit, a selection switch, an amplifying circuit, and an ADC.

The devices in the second signal link include the driver chip, the selection switch, the amplifying circuit, the ADC, a laser emitter, a TIA, and a receiving sensor.

The first signal link is a signal link from an output port of the controller, the driver chip, the reference signal conditioning circuit, the selection switch, the amplifying circuit, and the analog-to-digital converter to an input port of the controller.

The second signal link is a signal link from the output port of the controller, the driver chip, the laser emitter, the target object, the receiving sensor, the TIA, the selection switch, the amplifying circuit, and the ADC to the input port of the controller.

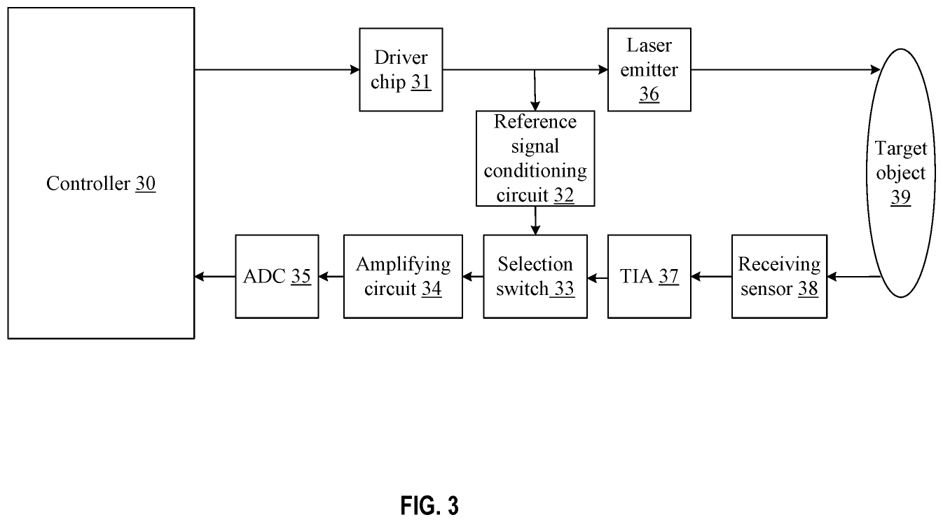

As shown in FIG. 3, the device for measuring includes a controller 30, a driver chip 31, a reference signal conditioning circuit 32, a selection switch 33, an amplifying circuit 34, an ADC 35, a laser emitter 36, a TIA 37, and a receiving sensor 38. The device for measuring calculates the time of flight between the device for measuring and a target object 39. The devices in the first signal link include the driver chip 31, the reference signal conditioning circuit 32, the selection switch 33, the amplifying circuit 34 and the ADC 35. The devices in the second signal link include the driver chip 31, the laser emitter 36, the receiving sensor 38, the TIA 37, the selection switch 33, the amplifying circuit 34, and the ADC 35. The selection switch 33 may be a single-pole double-throw switch. The controller 30 may control the selection switch 33 so that the amplifying circuit 34 is conducted with the reference signal conditioning circuit 32 or the TIA 37. When the amplifying circuit 34 and the reference signal conditioning circuit 32 are connected, the controller 30 transmits the signals via the first signal link. When the amplifying circuit 34 and the TIA 37 are connected, the controller 30 transmits the signals via the second signal link.

The first signal link is the signal link from the output port of the controller 30, the driver chip 31, the reference signal conditioning circuit 32, the selection switch 33, the amplifying circuit 34, and the ADC 35 to the input port of the controller 30. The second signal link is the signal link from the output port of the controller 30, the driver chip 31, the laser emitter 36, the target object 39, the receiving sensor 38, the TIA 37, the selection switch 33, the amplifying circuit 34, and the ADC 35 to the input port of the controller 30.

A control unit 30 may be realized in at least one hardware form of digital signals processing (DSP), a field-programmable gate array (FPGA), and a programmable logic array (PLA).

As shown in FIG. 3, the shared devices of the first signal link and the second signal link include the controller 30, the driver chip 31, the selection switch 33, the amplifying circuit 34 and the ADC 35. The non-shared devices of the first signal link and the second signal link include the reference signal conditioning circuit 32, the laser emitter 36, the TIA 37, and the receiving sensor 38. The controller 30, the driver chip 31, the selection switch 33, the amplifying circuit 34, and the ADC 35 are temperature sensitive devices. The reference signal conditioning circuit 32, the laser emitter 36, the TIA 37, and the receiving sensor 38 are non-temperature sensitive devices.

In one or more possible embodiments, the laser emitter includes a gallium nitride MOS tube and a laser diode.

The driver chip is configured to drive the laser emitter to emit laser signals according to the control signals from the control unit 30. The control signals may control the emission time, the number of emission times, emission power, duration and other parameters of the laser signals. The laser emitter may be one or more laser diodes and one or more gallium nitride MOS tubes. A plurality of the laser diodes may form an emitting array.

In one or more possible embodiments, the device parameters of the reference signal conditioning circuit and the TIA are the same and include the delay time. The reference signal conditioning circuit and the TIA realize the same function. The reference signal conditioning circuit shapes and filters the signals output by the driver chip to obtain signals with the same or similar signal features as the output signals of the TIA. For example, the reference signal conditioning circuit and the TIA are of the same model.

In one or more possible embodiments, the method further includes:
before transmitting the reference signals, transmitting first control signals to the selection switch; where, the first control signals are configured to control the selection switch to conduct the amplifying circuit and the reference signal conditioning circuit.

Alternatively, in one or more possible embodiments, the method further includes:
before transmitting the measurement signals, transmitting second control signals to the selection switch; where, the second control signals are configured to control the selection switch to conduct the amplifying circuit and the TIA.

The selection switch 33 may be a single-pole double-throw switch and controls the amplifying circuit 34 to be only conducted to either the reference signal conditioning circuit 32 or the TIA 37 at any time. Before transmitting the reference signals, the controller 30 transmits first control signals to the selection switch 33. The first control signals control the selection switch 33 to conduct the amplifying circuit 34 to the reference signal conditioning circuit 32. At this time, if the amplifying circuit 34 and the TIA 37 are disconnected, the reference signals are transmitted via the first signal link. Before transmitting the measurement signals, the controller 30 transmits the second control signals to the selection switch 33. The second control signals control the selection switch 33 to conduct the amplifying circuit 34 to the TIA 37. At this time, the reference signal conditioning circuit 32 and the amplifying circuit 34 are disconnected and thus the measurement signals are transmitted via the second signal link.

In one or more possible implementations, determining the time of flight corresponding to the target object according to the first transmission time, the second transmission time, and the delay time of the non-shared device includes determining the time of flight corresponding to the target object according to the following formula:

T₂−T₁=t_{laserT}+t_{TOF}+t_{laserR}+t_{TIA}−t′_{RS},

where T₂ is the second transmission time; T₁ is the first transmission time; t_{laserT} is delay time of the laser emitter; t_{TOF} is time of flight corresponding to the target object; t_{laserR} is delay time of the receiving sensor; t_{TIA} is delay time of the TIA, and t′_{RS} is delay time of the reference signal conditioning circuit.

Taking the device for measuring in FIG. 3 as an example to illustrate the method for measuring the time of flight of this application: assuming the laser emitter includes a gallium nitride MOS tube and a laser diode, the device for measuring transmits the reference signals in the first signal link before measuring the time of flight corresponding to the target object. The delay time in each delay link in the first signal link is shown in Table 2:

TABLE 2

| Delay link | Delay time |
|---|---|
| Emitting control delay | t1 |
| The delay of a driver chip | t2 |
| GaN conducting delay | |
| LD emitting-light delay | |
| Time of flight | |
| The photoelectric conversion delay of | |
| a receiving sensor | |
| Reference signal conditioning circuit | t7′ |
| The delay of an amplifying circuit | t8 |
| The conversion delay of ADC | t9 |
| The data transmission delay of ADC | t10 |

Then, the device for measuring transmits the measurement signals in the second signal link. The delay time of each delay link in the second signal link is shown in Table 3:

TABLE 3

| Delay link | Delay time |
|---|---|
| Emitting control delay | t1 |
| The delay of a driver chip | t2 |
| GaN conducting delay | t3 |
| LD emitting-light delay | t4 |
| Time of flight | t_{TOF} |
| The photoelectric conversion delay | t6 |
| of a receiving sensor | |
| The conversion delay of TIA | t7 |
| The delay of an amplifying circuit | t8 |
| The conversion delay of ADC | t9 |
| The data transmission delay of ADC | t10 |

In a case where the delay time of the reference signal conditioning circuit and the TIA are equal, that is, t7=t7′, time obtained by subtracting the first transmission time from the second transmission time is t=t3+t4+t_{TOF}+t6. t3, t4 and t6 are respectively GaN conducting delay time, LD emitting-light delay time, and the photoelectric conversion delay time of the receiving sensor. The foregoing three devices are all non-temperature sensitive devices. The specific values of t3, t4 and t6 may be obtained by the static calibration. t3, t4 and t6 are subtracted from t to finally obtain the accurate time of flight t_{TOF}.

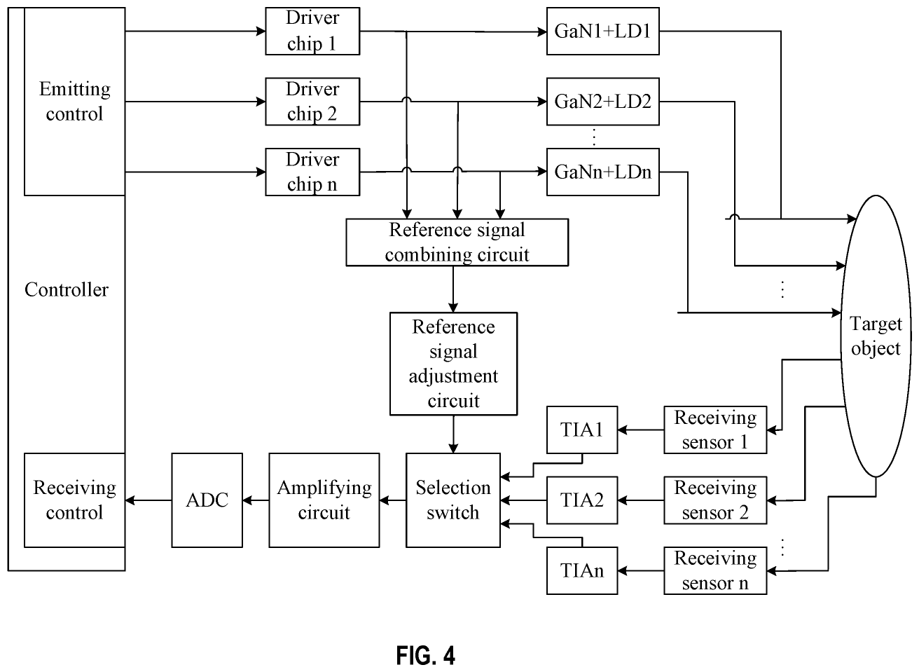

Referring to FIG. 4, an embodiment of this application provides a schematic structural diagram of a multi-channel device for measuring. Compared with a single-channel device for measuring, a reference signal combining circuit is added. In the embodiment of this application, the device for measuring is provided with n measurement channels. Each measurement channel includes a first signal link and a second signal link. n is an integer greater than 1. For example, devices in the first signal link corresponding to a channel 1 include a driver chip 1, the reference signal combining circuit, a reference signal conditioning circuit, a selection switch, an amplifying circuit, and an ADC. Devices in the second signal link include the driver chip 1, GaN1+LD1 (a laser emitter 1), a receiving sensor 1, TIA1, the selection switch, the amplifier circuit, and the ADC. For each multi-channel device for measuring, since temperature is a slowly changing quantity, it is not necessary to test the reference signal delay time of all channels in each transceiving cycle. The reference signal delay time of one of the channels is tested in one transceiving cycle so that the reference signal delay time of all channels may be measured once in every n transceiving cycles.

When implementing the embodiments of this application, since the shared device of the first transmission link and the second transmission link is the temperature-sensitive device, the delay time of the temperature-sensitive device may be eliminated according to the differential processing of the first transmission time and the second transmission time. Therefore, the measurement results of the time of flight are only related to the delay time of the non-temperature sensitive device. Therefore, the problem of inaccurate measurement of the time of flight of the target object caused by the temperature change of the device for measuring may be reduced, and the measurement accuracy of the device for measuring may be improved.

The embodiment of this application also provides a computer storage medium. The computer storage medium may store a plurality of instructions. The instructions are adapted to be loaded by a processor to execute the method of the embodiments shown in FIGS. 2-4 above. For the specific execution process, please refer to the specific description of the embodiments shown in FIGS. 2-4, which is not repeated here.

This application also provides a computer program product. The computer program product stores at least one instruction. The at least one instruction is loaded and executed by the processor to implement a method for measuring described in each of the above embodiments.

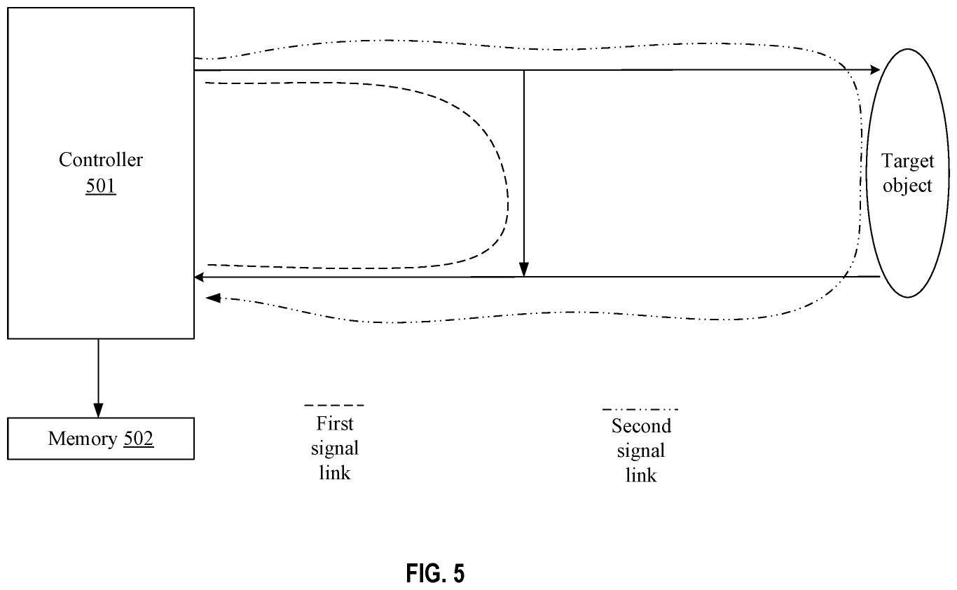

FIG. 5 is a schematic structural diagram of a device for measuring according to this application. As shown in FIG. 5, the device for measuring may include a controller 501, a memory 502, a first signal link, and a second signal link. A plurality of devices are provided in the first signal link and the second signal link.

The controller 501 and the memory 502 may be connected via a communication bus. For example, the communication bus is an SPI (Serial Peripheral Interface) bus.

The controller 501 may include one or more processing cores. The controller 501 uses various interfaces and lines to connect various parts of the entire device for measuring, and executes various functions and processes data of the device for measuring by running or executing instructions, programs, code sets, or instruction sets stored in the memory 502, and calling data stored in the memory 502. Optionally, the controller 501 may be realized with at least one hardware form of DSP, a FPGA, and a PLA. The controller 501 may integrate a central processing unit (CPU), a graphics processing unit (GPU), a modem, and the like or a combination thereof. The CPU mainly processes an operating system, a user interface, and application programs. The GPU is configured to render and draw content that needs to be displayed on a display. The modem is configured to process wireless communication. It may be understood that the foregoing modem may not be integrated into the controller 501, and may be implemented by one chip alone.

The memory 502 may include a random access memory (RAM), or a read-only memory (ROM). Optionally, the memory 502 includes a non-transitory computer-readable storage medium. The memory 502 may be configured to store the instructions, the programs, the codes, the code sets or the instruction sets. The memory 502 may include a program storage region and a data storage region. The program storage region may store instructions for implementing the operating system, instructions for at least one function (such as a system update function, etc.), and instructions for implementing each of the foregoing method embodiments. The data storage region may store data involved in each method embodiment above. Optionally, the memory 502 may also be at least one storage device positioned away from the foregoing main controller 501.

In the device for measuring shown in FIG. 5, the controller 501 may be configured to call the computer program stored in the memory 502, and specifically execute the following steps:
transmitting reference signals in a first signal link, and determining first transmission time of the reference signals in the first signal link;
transmitting measurement signals in a second signal link, and determining second transmission time of the measurement signals in the second signal link, where a shared device of the first signal link and the second signal link is a temperature-sensitive device, and a non-shared device of the first signal link and the second signal link is a non-temperature-sensitive device;
acquiring delay time of the non-shared device; and
determining time of flight corresponding to a target object according to the first transmission time, the second transmission time, and the delay time of the non-shared device.

Optionally, devices in the first signal link include a driver chip, a reference signal conditioning circuit, a selection switch, an amplifying circuit, and an ADC.

Devices in the second signal link include the driver chip, the selection switch, the amplifying circuit, the ADC, a laser emitter, a TIA, and a receiving sensor.

The first signal link is a signal link from an output port of the controller, the driver chip, the reference signal conditioning circuit, the selection switch, the amplifying circuit, and the ADC to an input port of the controller.

The second signal link is a signal link from the output port of the controller, the driver chip, the laser emitter, the target object, the receiving sensor, the TIA, the selection switch, the amplifying circuit, and the ADC to the input port of the controller.

Optionally, the laser emitter includes a gallium nitride MOS tube and a laser diode.

Optionally, the device parameters of the reference signal conditioning circuit and the TIA are the same and include the delay time.

Optionally, the controller 501 is also configured to execute:
before transmitting the reference signals, transmitting first control signals to the selection switch; where, the first control signals are configured to control the selection switch to conduct the amplifying circuit and the reference signal conditioning circuit.

Optionally, the controller 501 is also configured to execute:
before transmitting the measurement signals, transmitting second control signals to the selection switch; where, the second control signals are configured to control the selection switch to conduct the amplifying circuit and the TIA.

Optionally, the step of determining the time of flight corresponding to the target object according to the first transmission time, the second transmission time, and the delay time of the non-shared device includes:
determining the time of flight corresponding to the target object according to the following formula:

T₂−T₁=t_{laserT}+t_{TOF}+t_{laserR}+t_{TIA}−t′_{RS};
where T₂ is the second transmission time; T₁ is the first transmission time; t_{laserT} is the delay time of the laser emitter; t_{TOF} is the time of flight corresponding to the target object; t_{laserR} is the delay time of the receiving sensor; t_{TIA} is the delay time of the TIA, and t′_{RS} is the delay time of the reference signal conditioning circuit.

Optionally, acquiring the delay time of the non-shared device includes acquiring the pre-stored delay time of the non-shared device from the memory 502, where the delay time is determined by using a static calibration method.

The embodiment of FIG. 5 and the method embodiment of FIG. 2 are based on the same concept, and have the same technical effects. For the specific implementation process of FIG. 5, please refer to the description of FIG. 2, which is not repeated here.

This application also provides a LiDAR, including a device for measuring shown in FIG. 5, and the LiDAR in this application may be a multi-channel LiDAR.

The person skilled in the art can understand that all or part of procedures in methods of the foregoing embodiments can be implemented by instructing relevant hardware via computer program. The program can be stored in a computer readable storage medium. During execution, the computer program can include the procedures of the embodiments of the foregoing methods. A storage medium can be a magnetic disk, an optical disc, the read-only storage memory or the random storage memory, and so on.

The foregoing disclosed embodiments are only preferred embodiments of this application, which of course cannot be used to limit the scope of rights of this application. Therefore, equivalent changes made in accordance with the claims of this application still fall within the scope of the application.

What is claimed is:

1. A method for measuring time of flight, comprising:
transmitting reference signals in a first signal link, and determining first transmission time of the reference signals in the first signal link;
transmitting measurement signals in a second signal link, and determining second transmission time of the measurement signals in the second signal link, wherein a shared device of the first signal link and the second signal link is a temperature-sensitive device, and a non-shared device of the first signal link and the second signal link is a non-temperature-sensitive device;
acquiring delay time of the non-shared device; and
determining time of flight corresponding to a target object according to the first transmission time, the second transmission time, and the delay time of the non-shared device.

2. The method according to claim 1, wherein devices in the first signal link comprise a driver chip, a reference signal conditioning circuit, a selection switch, an amplifying circuit, and an analog-to-digital converter; and
devices in the second signal link comprise the driver chip, the selection switch, the amplifying circuit, the analog-to-digital converter, a laser emitter, a transimpedance amplifier, and a receiving sensor,
wherein the first signal link is a signal link from an output port of a controller, the driver chip, the reference signal conditioning circuit, the selection switch, the amplifying circuit, and the analog-to-digital converter to an input port of the controller, and
wherein the second signal link is a signal link from the output port of the controller, the driver chip, the laser emitter, the target object, the receiving sensor, the transimpedance amplifier, the selection switch, the amplifying circuit, and the analog- to-digital converter (ADC) to the input port of the controller.

3. The method according to claim 2, wherein the laser emitter comprises a gallium nitride metal-oxide-semiconductor (MOS) tube and a laser diode.

4. The method according to claim 2, wherein device parameters of the reference signal conditioning circuit and the transimpedance amplifier are the same and comprise delay time.

5. The method according to claim 2, further comprising:
before transmitting the reference signals, transmitting first control signals to the selection switch, wherein the first control signals are configured to control the selection switch to conduct the amplifying circuit and the reference signal conditioning circuit.

6. The method according to claim 2, further comprising:
before transmitting the measurement signals, transmitting second control signals to the selection switch, wherein the second control signals are configured to control the selection switch to conduct the amplifying circuit and the transimpedance amplifier.

7. The method according to claim 2, wherein the determining the time of flight corresponding to the target object according to the first transmission time, the second transmission time, and the delay time of the non-shared device comprises:
determining the time of flight corresponding to the target object according to the following formula:
T₂−T₁=t_{laserT}+t_{TOF}+t_{laserR}+t_{TIA}−t′_{RS},
wherein T₂ is the second transmission time; T₁ is the first transmission time; t_{laserT} is delay time of the laser emitter; t_{TOF} is the time of flight corresponding to the target object; t_{laserR} is delay time of the receiving sensor; t_{TIA} is delay time of the transimpedance amplifier; and t′_{RS} is delay time of the reference signal conditioning circuit.

8. The method according to claim 1, wherein acquiring the delay time of the non-shared device comprises:
acquiring pre-stored delay time of the non-shared device from a memory, wherein the pre-stored delay time of the non-shared device is determined by using a static calibration method.

9. A device for measuring time of flight, comprising:
a controller, a memory, a first signal link, and a second signal link, wherein the memory stores a computer program, and the computer program is configured to be loaded by the controller to execute a method which further comprises:
transmitting reference signals in the first signal link, and determining first transmission time of the reference signals in the first signal link;
transmitting measurement signals in the second signal link, and determining second transmission time of the measurement signals in the second signal link, wherein a shared device of the first signal link and the second signal link is a temperature-sensitive device, and a non-shared device of the first signal link and the second signal link is a non-temperature-sensitive device;
acquiring delay time of the non-shared device; and
determining time of flight corresponding to a target object according to the first transmission time, the second transmission time, and the delay time of the non-shared device.

10. A computer storage medium, wherein the computer storage medium stores a plurality of instructions, and the instructions are adapted to be loaded by a processor and execute a method, wherein the method comprises:
transmitting reference signals in a first signal link, and determining first transmission time of the reference signals in the first signal link;
transmitting measurement signals in a second signal link, and determining second transmission time of the measurement signals in the second signal link, wherein a shared device of the first signal link and the second signal link is a temperature-sensitive device, and a non-shared device of the first signal link and the second signal link is a non-temperature-sensitive device;
acquiring delay time of the non-shared device; and
determining time of flight corresponding to a target object according to the first transmission time, the second transmission time, and the delay time of the non-shared device.

11. A LiDAR, comprising a device for measuring time of flight, the device further comprising:
a controller, a memory, a first signal link, and a second signal link, wherein the memory stores a computer program, and the computer program is configured to be loaded by the controller to execute a method which further comprises:
transmitting reference signals in the first signal link, and determining first transmission time of the reference signals in the first signal link;
transmitting measurement signals in the second signal link, and determining second transmission time of the measurement signals in the second signal link, wherein a shared device of the first signal link and the second signal link is a temperature-sensitive device, and a non-shared device of the first signal link and the second signal link is a non-temperature-sensitive device;
acquiring delay time of the non-shared device; and
determining time of flight corresponding to a target object according to the first transmission time, the second transmission time, and the delay time of the non-shared device.
